(19) United States
(12) Patent Application Publication
(10) Pub. No.: US 2026/0108337 A1
(43) Pub. Date: Apr. 23, 2026

(54) ELECTRIC TOOTHBRUSH

(71) Applicant: CIXI SEAGO ELECTRONICS CO., LTD, Cixi (CN)

(72) Inventors: Yanzhong Cai, Cixi (CN); Weibing Peng, Cixi (CN); Yuli Wang, Cixi (CN)

(21) Appl. No.: 19/297,057

(22) Filed: Aug. 12, 2025

(30) Foreign Application Priority Data
Oct. 23, 2024 (CN) 202422559052.4

(51) Int. Cl. A61C 17/34; A46B 13/02

(52) U.S. Cl. CPC A61C 17/3472; A46B 13/023; A61C 17/3481; A61C 17/3454; A61C 17/3463

(57) ABSTRACT

The present disclosure provides an electric toothbrush, comprising: a support frame provided with a hollow part; a drive frame, wherein the drive frame is elastically connected to the support frame, the drive frame is located in the hollow part, the drive frame and the support frame are spaced apart, the drive frame has a drive shaft connector for connecting a toothbrush head; and a motor, wherein the motor is provided on the drive frame, the motor is able to drive the drive frame to swing or vibrate relative to the support frame during operation, so that the drive shaft connector can drive the toothbrush head to swing or vibrate.

### CROSS-REFERENCE TO RELATED APPLICATIONS

The present disclosure claims the priority to the Chinese patent application No. 202422559052.4 filed with the Chinese Patent Office on October 23, 2024, and entitled “ELECTRIC TOOTHBRUSH”, the contents of which are incorporated by reference herein in their entirety.

### TECHNICAL FIELD

The present disclosure relates to the technology field of oral hygiene and in particular to an electric toothbrush.

### BACKGROUND ART

An electric toothbrush produces high-frequency vibration in a toothbrush head by rapid rotation or vibration of an electric core, by which toothpaste is instantaneously decomposed into fine foam and deeply cleans crevices between teeth. Meanwhile, the fluttering of bristles can facilitate blood circulation in the oral cavity and has the effect of massaging gum tissue.

In the prior art, the drive mechanism of the built-in eccentric vibration motor is large in size, complex in structure, and high in cost. In addition, the toothbrush handle has a strong vibration sense, loud noise, and large attenuation of the vibration output to the toothbrush head, which consumes a lot of energy.

### SUMMARY

In order to overcome or alleviate the problems existing in the above-mentioned prior art, the present disclosure aims to provide an electric toothbrush, so that the vibration of the motor can be transmitted to the toothbrush head more, thereby reducing energy consumption.

The present disclosure provides an electric toothbrush, comprising:

a support frame provided with a hollow part;

a drive frame, wherein the drive frame and the support frame are connected through a connecting part and elastic parts, the drive frame is located in the hollow part, the drive frame and the support frame are spaced apart, the drive frame has a drive shaft connector for connecting a toothbrush head, the drive shaft connector is located at an upper end of the drive frame, the connecting part is connected to the drive shaft connector, the connecting part is connected to the support frame through the elastic parts, the elastic parts are located on left and right sides of the connecting part in a leftward/rightward direction of the electric toothbrush, there is a gap between the drive shaft connector and the elastic parts; and

a motor, wherein the motor is arranged on the drive frame, and the motor is able to drive the drive frame to swing or vibrate relative to the support frame during operation, so that the drive shaft connector is able to drive the toothbrush head to swing or vibrate.

In at least one possible embodiment, each of the elastic parts extends along the upward/downward direction of the electric toothbrush, and the connecting part extends along the leftward/rightward direction of the electric toothbrush.

In at least one possible embodiment, in the upward/downward direction, the connecting part is located at a lower end of each of the elastic parts, and the connecting part and the elastic parts are formed into a U shape, or

in the upward/downward direction of the electric toothbrush, the connecting part is located at an upper end of each of the elastic parts, and the connecting part and the elastic parts are formed into an n shape.

In at least one possible embodiment, in the upward/downward direction, the drive shaft connector extends beyond an uppermost end of each of the elastic parts.

In at least one possible embodiment, the drive shaft connector are provided with an annular groove, and the annular groove and the elastic parts are at the same position in the upward/downward direction.

In at least one possible embodiment, the drive shaft connector are located between two elastic parts, and an interval between the drive shaft connector and the elastic parts is 0.5 mm to 1 mm.

In at least one possible embodiment, the connecting part and the elastic parts both extend along the leftward/rightward direction of the electric toothbrush, and the connecting part and the elastic parts are formed into a straight-line shape.

In at least one possible embodiment, the elastic parts are sheet-shaped, and a thickness of each of the elastic parts along the frontward/rearward direction of the electric toothbrush is greater than a thickness of the elastic part along the leftward/rightward direction of the electric toothbrush.

In at least one possible embodiment, a shock absorber is provided in a gap between the drive frame and the support frame, the shock absorber is elastic, and when the drive frame swings or vibrates, the shock absorber can buffer an impact of the drive frame on the support frame.

In at least one possible embodiment, the drive shaft connector, the connecting part, the elastic parts and the support frame are integrally formed as a single piece.

According to the above-mentioned technical solution, the motor drives the drive frame to swing or vibrate relative to the support frame 1, so that the drive shaft connector drive the toothbrush head to swing or vibrate. Therefore, the vibration is less transmitted to the toothbrush handle, thereby reducing energy consumption and achieving a better brushing effect.

### BRIEF DESCRIPTION OF DRAWINGS

FIG. 1 shows an exploded view of a partial structure of an electric toothbrush according to one embodiment of the present disclosure.

FIG. 2 shows a sectional view of a toothbrush handle of an electric toothbrush according to one embodiment of the present disclosure.

FIG. 3 shows a sectional view of the toothbrush handle of an electric toothbrush according to one embodiment of the present disclosure.

FIG. 4 shows a front view of a support frame and a drive frame of an electric toothbrush according to one embodiment of the present disclosure.

FIG. 5 shows a top view of a support frame and a drive frame of an electric toothbrush according to one embodiment of the present disclosure.

FIG. 6 shows a front view of a support frame and a drive frame of an electric toothbrush according to another embodiment of the present disclosure.

FIG. 7 shows a front view of a support frame and a drive frame of an electric toothbrush according to another embodiment of the present disclosure.

FIG. 8 shows a front view of a support frame and a drive frame of an electric toothbrush according to another embodiment of the present disclosure.

FIG. 9 shows a front view of a support frame and a drive frame of an electric toothbrush according to yet another embodiment of the present disclosure.

### Description of the Reference Numerals

1 support frame; 11 battery; 12 circuit board; 13 hollow part; 14 waterproof ring; 15 waterproof ring mounting hole;

2 drive frame; 21 drive shaft connector; 211 annular groove; 22 motor groove; 23 counterweight groove; 24 elastic part; 25 connecting part; 26 shock absorber mounting groove;

3 counterweight;

4 pressure-sensitive switch;

5 motor; 51 eccentric block;

6 shock absorber;

7 drive shaft;

A upward/downward direction; F frontward/rearward direction; R leftward/rightward direction.

### DETAILED DESCRIPTION OF EMBODIMENTS

In order to more clearly explain the above-mentioned objectives, features and advantages of the present disclosure, this section describes in detail the specific embodiments of the present disclosure in combination with the drawings. In addition to the various embodiments described in this section, the present disclosure can also be implemented in other different ways. Those skilled in the art can make corresponding improvements, deformations and substitutions without departing from the spirit of the present disclosure. Therefore, the present disclosure is not limited by the specific embodiments disclosed in this section. The scope of protection of the present disclosure shall be based on the claims.

In one embodiment, an upward/downward direction A of the electric toothbrush in the following description indicates the direction in which an axis of the electric toothbrush extends, wherein an upper side indicates a side where the toothbrush head is located, and a lower side indicates a side where the toothbrush handle is located. A frontward/rearward direction F of the electric toothbrush represents a direction in which the bristles of the toothbrush head of the electric toothbrush extend, wherein a front side represents a side toward which the bristles face, and a rear side represents a side away from which the bristles face. A leftward/rightward R of the electric toothbrush is perpendicular to both the upward/downward A and the frontward/rearward direction F of the electric toothbrush.

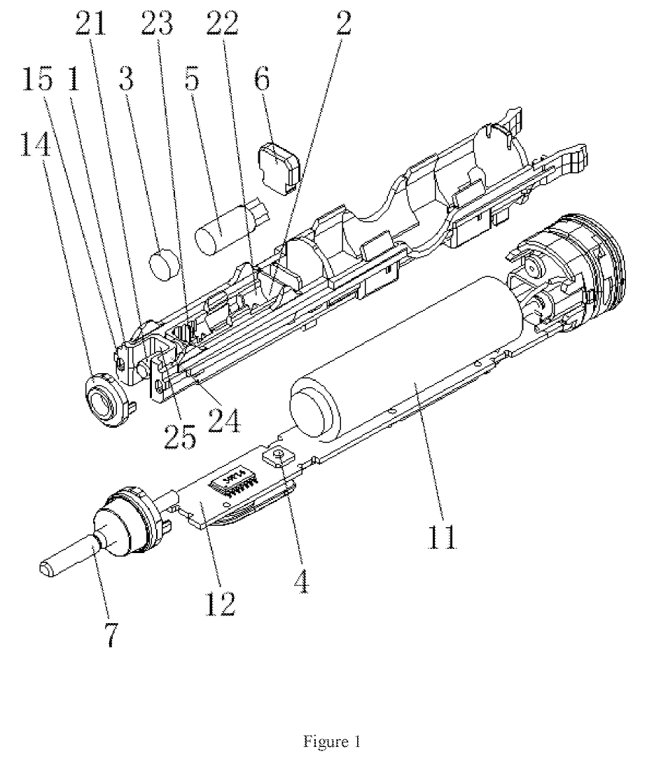

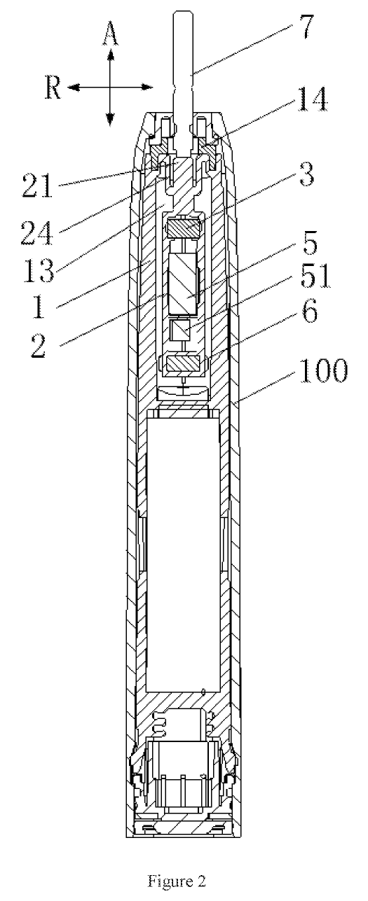

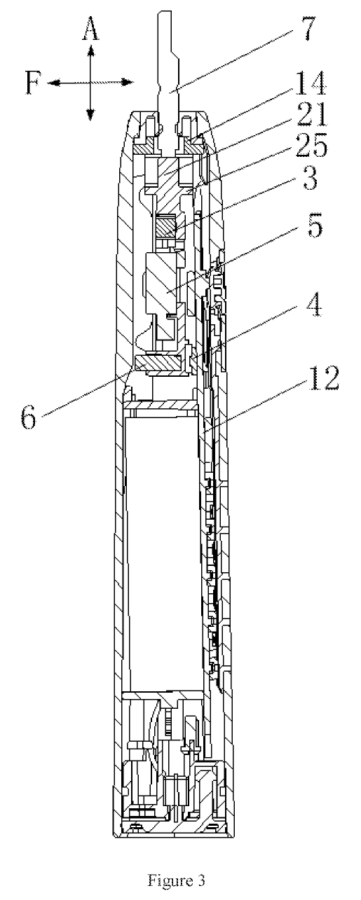

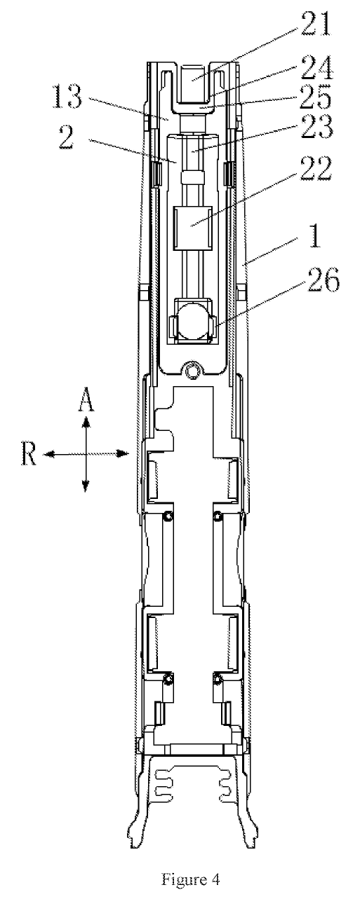

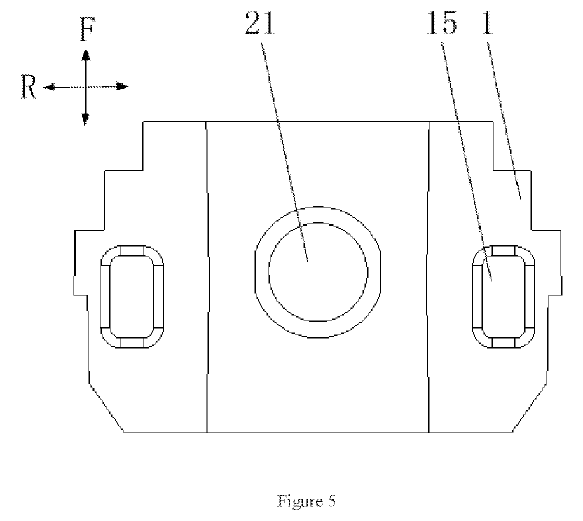

As shown in FIG. 1 to FIG. 5, the embodiment of the present disclosure provides an electric toothbrush, wherein the electric toothbrush comprises a toothbrush handle and a toothbrush head (not shown), and the toothbrush handle comprises a main body 100, a support frame 1, a drive frame 2, a counterweight 3, a pressure-sensitive switch 4, a motor 5, a shock absorber 6 and a drive shaft 7. The support frame 1, the drive frame 2, the counterweight 3, the pressure-sensitive switch 4, the motor 5 and the shock absorber 6 can be arranged inside the main body 100, and the drive shaft 7 extends from the main body 100 for connecting the toothbrush head. The toothbrush head can be connected to the drive shaft 7 in a detachable and replaceable way.

The support frame 1 can be configured to mount or fix other components such as a battery 11 and a circuit board 12. The support frame 1 can be provided with a hollow part 13. The hollow part 13 can be located in the middle position in the leftward/rightward direction R of the electric toothbrush. The hollow part 13 can be passed through along the frontward/rearward direction F of the electric toothbrush.

The pressure-sensitive switch 4 can be connected to the circuit board 12. The pressure-sensitive switch 4 is configured to control the power switch of the electric toothbrush. The pressure-sensitive switch 4 can enable the user to conveniently control the turning on and off of the electric toothbrush, thereby improving the convenience of user operation and the user experience.

The drive frame 2 can comprise a motor groove 22 and a counterweight groove 23, and the upper side of the drive frame 2 can be connected with a drive shaft connector 21. The drive shaft connector 21 can be cylindrical, and the drive shaft connector 21 is fixedly connected to the drive shaft 7, and the drive shaft 7 is configured to connect the toothbrush head.

The drive frame 2 and the support frame 1 can be elastically connected through the elastic parts 24, the drive frame 2 can be located in the hollow part 13, and the drive frame 2 is spaced apart from the support frame 1 as a whole. The motor 5 can be connected to the drive frame 2, and the vibration of the motor 5 can drive the drive frame 2 to swing or vibrate relative to the support frame 1, and then the swing or vibration is transmitted to the drive shaft connector 21. By elastically connecting the drive frame 2 and the support frame 1 and spacing them as a whole, the toothbrush head connected to the drive shaft 7 can have a certain degree of freedom of movement, so that the toothbrush head can be subjected to forces in different directions to better clean the teeth and massage the gums.

In the upward/downward direction A of the electric toothbrush, the drive shaft connector 21 can be located on the upper side of the motor groove 22. The output shaft of the motor 5 can be mounted with an eccentric block 51, so that vibration can be generated when the motor 5 rotates, and the motor 5 is accommodated in the motor groove 22. The counterweight groove 23 can be located on the upper side of the motor groove 22, and the counterweight 3 is accommodated in the counterweight groove 23. In the upward/downward direction A of the electric toothbrush, the eccentric block 51 can be located on the lower side of the motor 5, and the counterweight 3 can be located on the upper side of the motor 5.

The counterweight 3 can increase the overall weight of the drive frame 2, balance the vibration generated when the motor is running, avoid imbalance caused by vibration, keep the electric toothbrush stable during use, and make the movement of the toothbrush head more stable and efficient.

The drive frame 2 can be elastically connected to the support frame 1 through the drive shaft connector 21, the connecting part 25 and the elastic parts 24. The connecting part 25 can be connected to the drive shaft connector 21, and the connecting part 25 can be sheet-shaped, and the connecting part 25 can surround the drive shaft connector 21. The drive shaft connector 21 is connected to the elastic parts 24 through the connecting part 25, and the connecting part 25 is connected to the support frame 1 through two elastic parts 24. The elastic parts 24 can be located on the left and right sides of the connecting part 25 in the leftward/rightward direction R. The dimensions of the connecting part 25 and the elastic parts 24 along the frontward/rearward direction F can be the same. The connecting part 25 and the elastic parts 24 can be formed into a U shape, the connecting part 25 forms the bottom of the U shape, and each of the elastic part 24 comprises two elastic sheets, forming two arms of the U shape. In the upward/downward direction A, the connecting part 25 can be located at the lower end of each of the elastic parts 24. The elastic sheets can be in the shape of sheets extending along the upward/downward direction A and the frontward/rearward direction F. There is a gap between the drive shaft connector 21 and the elastic parts 24. The drive shaft connector 21 is located between the two elastic sheets. The drive shaft connector 21 and the elastic sheets can be spaced 0.5 to 1 mm apart. The width of each of the elastic parts 24 (the dimension along the frontward/rearward direction F) can be 4.9 to 5.5 mm. The dimension (thickness) of the connecting part 25 along the leftward/rightward direction can be above 1.5 mm. It can be understood that the thickness of the connecting part 25 can be adaptively changed according to the length of the drive shaft connector 21. The elastic parts 24 can make the motor 5 drive the drive frame 2 to swing or vibrate relative to the support frame 1. The elastic parts 24 can absorb and buffer the external force, such as vibration or impact during use, reduce damage to the overall structure, and improve the service life and grip comfort.

It can be understood that the drive frame can move in multiple directions driven by the motor 5. This multi-directional movement can not only cover different surfaces of the teeth, but also more effectively remove dirt and plaque in the gaps between the teeth.

The elastic parts 24 can be arranged on the left and right sides of the connecting part 25 in the leftward/rightward direction R. The elastic parts 24 can be bendable sheet-shaped, and the size (thickness) of each of the sheet-shaped elastic parts in the frontward/rearward direction can be greater than the size (thickness) in the leftward/rightward direction. Here, the size (thickness) of each of the sheet-shaped elastic parts in the leftward/rightward direction does not comprise the size (thickness) of the interval between the two elastic parts 24, that is, it refers to the thickness of each of the two elastic parts 24 entity. Thus, the elastic parts are easy to bend and deform in the leftward/rightward direction R of the electric toothbrush, but not easy to bend and deform in the frontward/rearward direction F of the electric toothbrush (still able to deform). In this way, the drive frame 2 can easily swing in the leftward/rightward direction relative to the support frame 1, thereby driving the toothbrush head to swing or vibrate in the leftward/rightward direction R, thereby cleaning the teeth and/or gums.

The drive shaft connector 21 can have a fulcrum. It is understood that the fulcrum is a virtual position defined artificially, and is not a support point existing in the structure. When the motor 5 drives the drive frame 2 to swing or vibrate, the drive frame 2 can swing or vibrate around the fulcrum.

Optionally, in this embodiment, the drive shaft connector 21, the elastic parts 24, the connecting part 25 and the support frame 1 can be integrally formed as a single piece, so that the overall structural strength and stability of the support frame 1 and the drive frame 2 are high.

Optionally, the drive shaft connector 21, the elastic parts 24, the connecting part 25 and the support frame 1 can all be made of a mixture of polyamide 66 (PA66) and glass fiber. In other possible embodiments, materials with a tensile strength of 90-260 MPa and a bending modulus of 3500-8000 MPa can be selected, including but not limited to materials mixed with polyamide 66 and glass fiber in different proportions, materials mixed with polyamide 6 and glass fiber in different proportions, and polypropylene. As the content of glass fiber increases, the tensile strength (in MPa) and bending modulus (in MPa) of the material can be improved, so that the rigidity and strength of the material are improved.

Furthermore, the drive shaft connector 21, the elastic parts 24, the connecting part 25 and the support frame 1 can all be made of a mixture of polyamide 66 (PA66) and 15% to 30% glass fiber, so that the material can have high rigidity and strength, and the impact resistance can meet the requirements.

For example, two waterproof ring mounting holes 15 can be provided at the front end of the support frame 1, and the two waterproof ring mounting holes 15 can be provided on the left and right sides of the drive shaft connector 21 in the leftward/rightward direction R of the electric toothbrush. The waterproof ring mounting holes 15 can be configured to connect the waterproof ring 14. The waterproof ring 14 is configured to prevent water or foam from entering the interior of the main body 100.

The shock absorber 6 can be connected to the drive frame 2, and at least a portion of the shock absorber 6 is located in the gap between the drive frame 2 and the support frame 1. The shock absorber 6 has elasticity, for example, the shock absorber 6 can be rubber. When the drive frame swings or vibrates, the shock absorber 6 can effectively absorb and alleviate the vibration transmitted to the support frame 1, reduce the vibration intensity transmitted to the hand of the user, and improve the comfort of use. For example, the shock absorber 6 can be mounted on the drive frame 2 along the frontward/rearward direction F, and the size of the shock absorber 6 along the leftward/rightward direction R is greater than the size of the drive frame 2 along the leftward/rightward direction R, so that a portion of the shock absorber 6 is located in the gap between the drive frame 2 and the support frame 1.

The shock absorber 6 can protect the motor 5 and other components, and can also reduce the noise generated when the motor 5 is running, thereby making the electric toothbrush quieter during use and improving the user experience. In addition, the shock absorber 6 can also buffer external impacts, reduce damage caused by falling, and extend the service life of the electric toothbrush.

Furthermore, the drive frame 2 can be provided with a shock absorber mounting groove 26, and the shock absorber 6 can be mounted in the shock absorber mounting groove 26. In the upward/downward direction A of the electric toothbrush, the shock absorber mounting groove 26 can be provided at the lower side of the motor groove 22, and the shock absorber 6 can be provided at the lower side of the motor 5.

When using the electric toothbrush of the present disclosure, the user can turn on the electric toothbrush through the pressure-sensitive switch 4, turn on the power source, and initiate the motor 5 to rotate. The motor 5 drives the eccentric block 51 to rotate, so that the drive frame 2 swings or vibrates with the fulcrum as the axis, and transmits the power to the drive shaft connector 21, and the toothbrush head can swing or vibrate in multiple directions through the drive shaft 7. The drive frame 2 and the toothbrush head are respectively located at the two ends of the fulcrum. The lever principle is used to amplify the swing or vibration of the drive frame 2 at the bristle position of the toothbrush head. This swing or vibration can effectively clean the tooth surface and hard-to-reach areas, and improve the brushing effect.

The electric toothbrush of the present disclosure has the following beneficial effects.

(1) The motor 5 drives the drive frame 2 to swing or vibrate relative to the support frame 1, thereby driving the drive shaft connector 21 to make the toothbrush head swing or vibrate synchronously. This design can effectively reduce the vibration transmitted to the toothbrush handle, thereby reducing energy consumption and improving the effect of brushing. In addition, the structure is simple, and the rotational motion of the motor 5 can be easily converted into the swing or vibration of the drive shaft connector 21, making the production cost lower.

(2) The shock absorber 6 absorbs and buffers the impact of the drive frame 2 on the support frame 1, so that less vibration is transmitted to the hand of the use. The vibration intensity transmitted to the hand of the user is reduced, the comfort of use is improved, and the noise is reduced, making the electric toothbrush quieter during use and improving the user experience.

(3) When the electric toothbrush falls, the shock absorber 6 can buffer the external impact, so that the motor 5 is less impacted, thereby reducing the possibility of damage to the motor 5 and extending the service life of the electric toothbrush.

(4) The counterweight 3 can increase the overall weight of the drive frame 2, thereby balancing the vibration generated by the operation of the motor 5, so that the electric toothbrush remains stable during use, and the movement of the toothbrush head is smoother and more efficient.

(5) The elastic parts 24 can absorb and buffer the external force applied to the toothbrush head, such as vibration or impact during use, reducing damage to the overall structure, and improving the service life and grip comfort.

(6) The drive shaft connector 21, the elastic parts 24, the connecting part 25 and the support frame 1 are integrally formed as a single piece, so that the overall structural strength of the support frame 1 and the drive frame 2 is relatively high.

The present disclosure is not limited to the above embodiments. Those skilled in the art can make various modifications to the above embodiments of the present disclosure under the teaching of the present disclosure without departing from the scope of the present disclosure. In addition, the following description is also made.

(1) In the above embodiment, the shock absorber 6 is provided on the drive frame 2, but the present disclosure is not limited thereto. The shock absorber can also be connected to the support frame, as long as at least a portion of the shock absorber is located in the gap between the drive frame and the support frame.

(2) In the above embodiment, the elastic parts 24 are sheet-shaped, but the present disclosure is not limited thereto. The elastic parts 24 can be columnar or in other shapes. For example, the sheet-shaped elastic parts of the above embodiment can be replaced by a plurality of columnar elastic parts.

In one embodiment, the electric toothbrush of this embodiment of the present disclosure is similar in overall structure to the electric toothbrush of the other embodiment, and the same reference numerals are used to represent the same or similar parts in the two embodiments. The main difference between this embodiment and the other embodiment lies in the structure of the drive shaft connector 21.

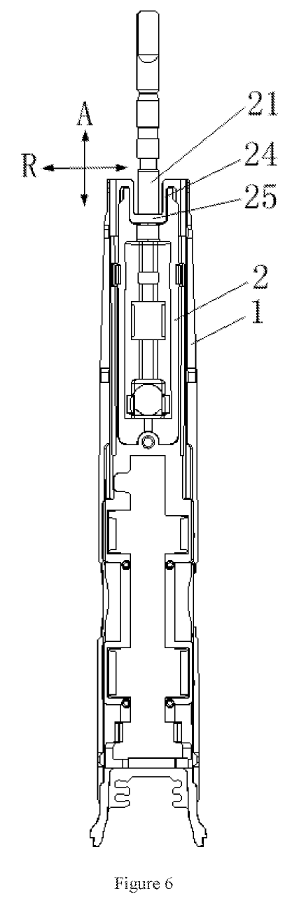

As shown in FIG. 6, the drive shaft connector 21 can extend in the upward/downward direction A to the uppermost end beyond the elastic parts 24. A longer drive shaft connector 21 can make the toothbrush head farther from the fulcrum, and by using the lever principle, the toothbrush head can swing with a larger amplitude.

In one embodiment, the electric toothbrush of this embodiment of the present disclosure has a similar overall structure to the electric toothbrush of the other embodiment, and the same reference numerals are used to represent the same or similar parts of the two embodiments. The main difference between this embodiment and the other embodiment lies in the structure of the drive shaft connector 21.

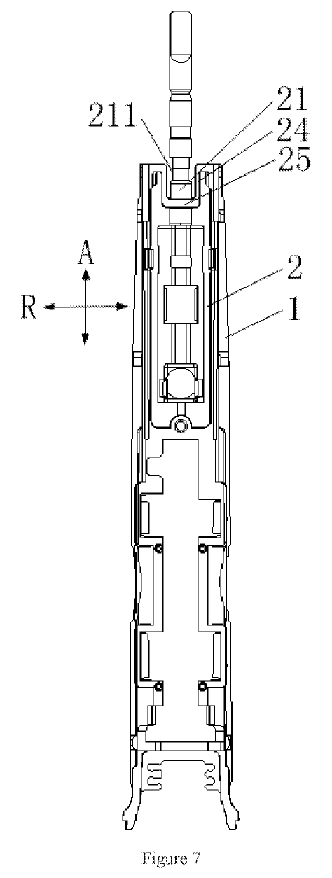

As shown in FIG. 7, the drive shaft connector 21 can be provided with an annular groove 211, and the annular groove 211 and the elastic parts 24 can be at the same position in the upward/downward direction A, so that the gap between the drive shaft connector 21 and the elastic parts 24 can be larger, providing more sufficient swing space for the drive shaft connector 21.

In one embodiment, the electric toothbrush of this embodiment of the present disclosure has a similar overall structure to the electric toothbrush of the other embodiment, and the same reference numerals are used to represent the same or similar parts in the two embodiments. The main difference between this embodiment and the other embodiment lies in the structure of the elastic parts 24.

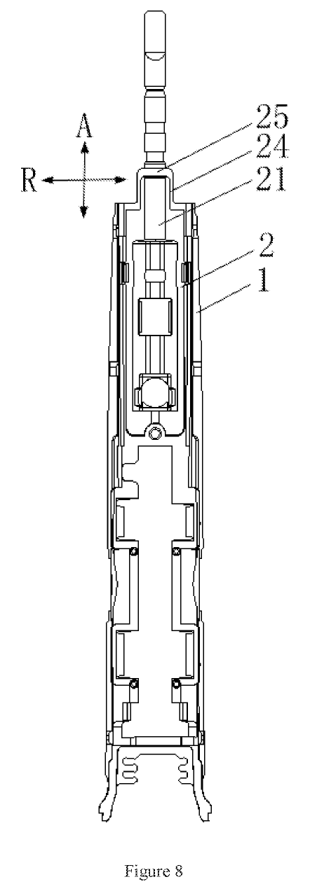

As shown in FIG. 8, the connecting part 25 and the elastic parts 24 can be formed into an n-shape, the connecting part 25 forms the top of the n-shape, and each of the elastic parts 24 comprises elastic sheets to form two arms of the n-shape. In the upward/downward direction A, the connecting part 25 can be located at the upper ends of the elastic parts 24.

The drive shaft connector 21 can be provided with a recessed portion, and the recessed portion and the elastic parts 24 can be located at the same position in the upward/downward direction A, so that the gap between the drive shaft connector 21 and the elastic parts 24 can be larger, providing the drive shaft connector 21 with more sufficient swinging space.

In one embodiment, the electric toothbrush of this embodiment of the present disclosure has a similar overall structure to the electric toothbrush of the other embodiment, and the same reference numerals are used to represent the same or similar parts in the two embodiments. The main difference between this embodiment and the other embodiment lies in the structure of the elastic parts 24.

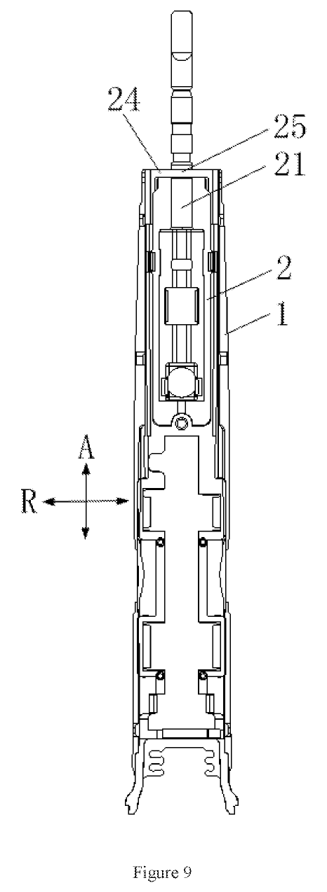

As shown in FIG. 9, the connecting part 25 and the elastic parts 24 both extend in the leftward/rightward direction R and the frontward/rearward direction F. The connecting part 25 and the elastic parts 24 can be formed in a straight-line shape. Each of the elastic parts 24 comprises elastic sheets. Two elastic parts 24 can be provided at the left and right sides of the connecting part 25.

It should be understood that at least part of aspects or features of the above-mentioned embodiments, implements or examples can be appropriately combined.

It can be understood that, in the present disclosure, when the number of parts or components is not specifically limited, the number thereof can be one or multiple, where the term "multiple" refers to two or more. In the case where the number of parts or components shown in the drawings and/or described in the description is a specific quantity, such as two, three, or four, the specific quantity is usually exemplary and not restrictive and can be construed as multiple, i.e., two or more. However, this does not mean that the number “one” is excluded in the present disclosure.

In the present disclosure, unless otherwise expressly stated or defined, the terms "mount", "assemble", "assembling", "couple", "connect", "link", "attach", "abut", "communicate", “communicating”, "conduct”, "fix", "fasten", and the like should be construed in a broad sense, for example, directly or indirectly. For example, connection can be fixed connection, detachable connection, or integral connection, or can be mechanical connection or electrical connection, or can be direct connection or indirect connection through an intermediate medium, or internal communication between two elements or interaction between two elements, unless otherwise expressly stated or defined. For example, communication/conduction or the like can be direct communication/conduction, or indirect communication/conduction through an intermediate medium. It will be appreciated by those of ordinary skill in the art that the specific meanings of the above terms in the present disclosure can be understood according to specific situations.

In the present disclosure, unless otherwise expressly stated or defined, a component arranged/ mounted/ positioned/ accommodated/ disposed in, within, or inside another component can be either of: the component being partially or mostly positioned within another component; and the component being wholly accommodated within another component.

Although the present disclosure is described in detail using the above embodiments, it is apparent to those skilled in the art that the present disclosure is not limited to the embodiments described in this specification. The present disclosure can be modified and implemented as a variant embodiment without departing from the spirit and scope of the present disclosure determined by the claims. Therefore, the description in this specification is for illustrative purposes only and is not intended to limit the present disclosure in any way.

1. An electric toothbrush, wherein the electric toothbrush comprises:
a support frame provided with a hollow part;
a drive frame, wherein the drive frame and the support frame are connected through a connecting part and elastic parts, the drive frame is located in the hollow part, the drive frame and the support frame are spaced apart, the drive frame is provided with a drive shaft connector for connecting a toothbrush head, the drive shaft connector is located at an upper end of the drive frame, the connecting part is connected to the drive shaft connector, the connecting part is connected to the support frame through the elastic parts, the elastic parts are located on left and right sides of the connecting part in a leftward/rightward direction of the electric toothbrush, and a gap is arranged between the drive shaft connector and the elastic parts; and
a motor, wherein the motor is arranged on the drive frame, and the motor is able to drive the drive frame to swing or vibrate relative to the support frame during operation, so that the drive shaft connector is able to drive the toothbrush head to swing or vibrate.

2. The electric toothbrush according to claim 1, wherein the elastic parts extend along an upward/downward direction of the electric toothbrush, and the connecting part extends along the leftward/rightward direction of the electric toothbrush.

3. The electric toothbrush according to claim 2, wherein, in the upward/downward direction, the connecting part is located at a lower end of each of the elastic parts, and the connecting part and the elastic parts are formed into a U shape, or
in the upward/downward direction, the connecting part is located at an upper end of each of the elastic parts, and the connecting part and the elastic parts are formed into an n shape.

4. The electric toothbrush according to claim 1, wherein in the upward/downward direction of the electric toothbrush, the drive shaft connector extends beyond an uppermost end of each of the elastic parts.

5. The electric toothbrush according to claim 2, wherein the drive shaft connector is provided with an annular groove, and the annular groove and the elastic parts are at a same position in the upward/downward direction.

6. The electric toothbrush according to claim 2, wherein the drive shaft connector is located between two elastic parts, and an interval between the drive shaft connector and each of the elastic parts is 0.5mm to 1 mm.

7. The electric toothbrush according to claim 1, wherein the connecting part and the elastic parts both extend along the leftward/rightward direction of the electric toothbrush, and the connecting part and the elastic parts are formed in a straight-line shape.

8. The electric toothbrush according to claim 1, wherein the elastic parts are sheet-shaped, and a thickness of each of the elastic part along the frontward/rearward direction of the electric toothbrush is greater than a thickness of the elastic part along the leftward/rightward direction of the electric toothbrush.

9. The electric toothbrush according to claim 1, wherein a shock absorber is provided in a gap between the drive frame and the support frame, the shock absorber is elastic, and when the drive frame swings or vibrates, the shock absorber is able to buffer an impact of the drive frame on the support frame.

10. The electric toothbrush according to claim 1, wherein the drive shaft connector, the connecting part, the elastic parts and the support frame are integrally formed as a single piece.

11. The electric toothbrush according to claim 4, wherein the drive shaft connector is provided with an annular groove, and the annular groove and the elastic parts are at a same position in the upward/downward direction.

12. The electric toothbrush according to claim 4, wherein the drive shaft connector is located between two elastic parts, and an interval between the drive shaft connector and each of the elastic parts is 0.5mm to 1 mm.
